(19) United States
(12) Patent Application Publication
(10) Pub. No.: US 2026/0122059 A1
(43) Pub. Date: Apr. 30, 2026

(54) LOGIN AUTHORIZATION METHODS AND APPARATUSES

(71) Applicant: Alipay (Hangzhou) Digital Service Technology Co., Ltd., Hangzhou (CN)

(72) Inventor: Shangcheng SHI, Hangzhou (CN)

(21) Appl. No.: 19/429,459

(22) Filed: Dec. 22, 2025

Related U.S. Application Data
(63) Continuation of application No. PCT/CN2024/104036, filed on Jul. 5, 2024.

(30) Foreign Application Priority Data
Jul. 6, 2023 (CN) 202310827868.8

(51) Int. Cl. H04L 9/40

(52) U.S. Cl. CPC H04L 63/083; H04L 63/20

(57) ABSTRACT

A login authorization method is applied to an authorization server, and includes: when a user logs in to a front-end application (app) installed on a user terminal, delivering an authorization credential to a background server of an H5 page in the front-end app in response to an authorization request sent on the H5 page; delivering a token to the background server in response to a token application request that carries the authorization credential and that is sent by the background server; and in response to user login information obtaining request that carries the token and that is sent by the background server, delivering user login information of the front-end app to the background server, wherein the background server completes login on the H5 page based on the user login information.

### CROSS-REFERENCE TO RELATED APPLICATIONS

This application is a continuation application of International Application No. PCT/CN2024/104036, filed July 5, 2024, which claims priority to Chinese Patent Application No. 202310827868.8, filed on July 6, 2023, the entire contents of both of which are incorporated herein by reference.

### TECHNICAL FIELD

The present invention relates to the field of computer technologies, and in particular, to login authorization methods and apparatuses.

### BACKGROUND

Currently, many H5 web applications have been deployed in large-scale mobile applications, referred to as manufacturer apps. These H5 applications authenticate identities of terminal users through login authorization services provided by the manufacturer apps without a need for entering of additional account passwords. In such login authorization services, most of the manufacturer apps use a universal OAuth2.0 protocol and adapts to a certain extent. However, an initial design objective of the OAuth2.0 protocol is to serve a user authorization service of a PC-end webpage. Therefore, adaptation performed by manufacturers may violate an original security design of the protocol and introduce a risk of disclosing user account information.

### SUMMARY

According to a first aspect of this specification, a login authorization method is applied to a service provider end, and the method includes: when a user logs in to a front-end app of the service provider end, delivering an authorization credential to a background server of an H5 page in the front-end app in response to an authorization request sent on the H5 page; delivering a token to the background server in response to a token application request that carries the authorization credential and that is sent by the background server; and in response to user login information obtaining request that carries the token and that is sent by the background server, delivering user login information of the front-end app to the background server, wherein the background server completes login on the H5 page based on the user login information.

According to a second aspect of this specification, a login authorization method is applied to a mobile terminal. A front-end app provided by a service provider end is installed on the mobile terminal, an H5 page is embedded in the front-end app, and the method includes: logging in to the front-end app, and initiating an authorization request on the H5 page; and obtaining an authorization credential returned by the service provider end for the authorization request, and sending the authorization credential to a background server of the H5 page, wherein the background server applies for a token from the service provider end, obtains user login information of the front-end app based on the token, and completes login on the H5 page based on the user login information.

According to a third aspect of this specification, an authorization server includes a processor, and a memory storing instructions executable by the processor. An H5 page is embedded in a front-end app; and the front-end app is configured to: in a login state, in response to an authorization request sent on the H5 page, apply for an authorization credential from the authorization server, and return the authorization credential to the H5 page; and the processor of the authorization server is configured to: in response to a request of the front-end app for the authorization credential, generate the authorization credential, deliver the authorization credential to the front-end app, and deliver a token to a background server of the H5 page in response to a token application request that carries the authorization credential and that is sent by the background server.

According to a fourth aspect, a mobile terminal is installed with a front-end app provided by a service provider end, and includes a processor, and a memory storing instructions executable by the processor. An H5 page is embedded in the front-end app, and for the mobile terminal to log in to the H5 page based on a login state of the front-end app, the processor is configured to: initiate an authorization request on the H5 page; send the authorization request to an authorization server of the service provider end by using the front-end app; and obtain, by using the front-end app, an authorization credential returned by the authorization server for the authorization request, and send the authorization credential to a background server of the H5 page, wherein the background server applies for a token from the authorization server, obtains user login information of the front-end app based on the token, and completes login on the H5 page based on the user login information.

### BRIEF DESCRIPTION OF DRAWINGS

The following briefly describes the accompanying drawings of the specification. Clearly, the accompanying drawings in the following descriptions show merely example embodiments of this specification.

FIG. 1 is a schematic diagram of a login authorization system, according to one or more embodiments.

FIG. 2 is a flowchart of a login authorization method applicable to a service provider end, according to one or more embodiments.

FIG. 3 is a flowchart of a login authorization method applicable to a mobile terminal, according to one or more embodiments.

FIG. 4 is a schematic diagram illustrating a working procedure of a login authorization method, according to one or more embodiments.

FIG. 5 is a schematic diagram of a login authorization apparatus, according to one or more embodiments.

### DETAILED DESCRIPTION OF EMBODIMENTS

The following describes example embodiments of this specification with reference to the accompanying drawings. Clearly, the described embodiments are merely some but not all embodiments consistent with this specification. All other embodiments obtained by a person of ordinary skill in the art based on the described embodiments without creative efforts shall fall within the protection scope of this specification.

It is worthwhile to note that, in some embodiments, steps of the method described below are not necessarily performed in the order shown and described in this specification. In some embodiments, the method can include more or less steps than those described in this specification. In addition, a single step described in this specification may be divided into a plurality of steps, and a plurality of steps described in this specification may also be combined into a single step.

A person skilled in the art can understand that the terms used in the embodiments of this specification are merely used to describe specific embodiments, and are not intended to limit this application. The terms "a", "an", and "the" are intended to include plural forms, unless otherwise specified in the context clearly.

Currently, many H5 web applications have been deployed in large-scale mobile applications (apps). These H5 web applications authenticate identities of terminal users by using a login authorization service provided by a large-scale mobile application without a need for entering of an additional account password. In such a login authorization service, most of the large-scale mobile apps use a universal OAuth2.0 protocol and adapt to a certain degree. However, an initial design objective of the OAuth2.0 protocol is to serve a user authorization service of a PC-end webpage. Therefore, adaptation performed by manufacturers of the large mobile apps may violate an original security design of the protocol and introduce new risks.

An example in which the users log in to a merchant server through a login authorization function provided by a manufacturer server is used to describe an application principle of the OAuth2.0 protocol at a PC end. The following describes a login authorization procedure based on the OAuth2.0 protocol at the PC end.

Step 1: An authorization initialization request is initiated to a client through a browser when a user accesses the client (a merchant server).

Step 2: The client (merchant server) sends an authorization request (namely, a 302 redirect request in OAuth2.0) to the user (browser). The authorization request includes a callback address specified by the client and an identifier of the client.

Step 3: The browser is redirected to an authorization page. The authorization page is provided by an authorization server, and the authorization page provides the user with related information submitted by the merchant server in the authorization server and an access permission range that can be obtained by the merchant server after authorization. The user authorizes the client on the authorization page, that is, sends the authorization request to the authorization server (manufacturer server).

Step 4: After receiving the authorization request of the user (browser), the authorization server (manufacturer server) verifies whether the callback address redirect_url in the authorization request is consistent with a callback address submitted when the client registers, and verifies whether the identifier appid in the authorization request is consistent with an identifier distributed by the manufacturer server when the client registers. If verification on both the callback address redirect_url and the identifier appid succeeds, the authorization server (manufacturer server) generates an authorization credential code.

Step 5: The authorization server (manufacturer server) returns the authorization credential code to the user (browser).

Step 6: The user (browser) sends the authorization credential code to the client (merchant server) based on the callback address redirect_url in the authorization request.

Step 7: The client (merchant server) applies for a token access_token from the authorization server (manufacturer server) based on the authorization credential.

Step 8: The client (merchant server) uses the token access_token to request a resource from a resource server.

Step 9: The resource server returns the corresponding resource to the client (merchant server) after determining that the token is correct.

It can be seen from the above procedure that, in the login authorization procedure based on the OAuth2.0 protocol at the PC end, steps 5 and 6 are atomic operations performed at the browser end, and cannot be interfered or interrupted by the outside. Therefore, it can be ensured that the authorization credential code can be transmitted to a valid client.

In some embodiments, when an OAuth2.0 protocol is applied to a mobile client, an authentication procedure may include the following steps.

Step 1: A user initiates a login authorization request to a service provider on an H5 page. The service provider includes a manufacturer app and a manufacturer server.

Step 2: The login authorization request initiated by the user is received by the manufacturer app. The manufacturer app extracts a current domain name current_url based on the login authorization request, and determines an identity of the H5 page based on the extracted domain name current_url and an identifier appid of a third-party application in the login authorization request.

Step 3: After determining that the H5 page is valid, the manufacturer app sends an authorization request (including appid and current_url) to the manufacturer server.

Step 4: The manufacturer server verifies whether appid and current_url in the authorization request are consistent with related information submitted when the third-party application registers, and generates an authorization credential code after verification succeeds.

Step 5: The manufacturer server delivers the authorization credential code to the manufacturer app.

Step 6: The manufacturer app sends the authorization credential code to the H5 page.

Step 7: The user sends the authorization credential code to the third-party application on the H5 page.

Step 8: The third-party application uses the authorization credential code to apply for a token access_token from the manufacturer server.

Step 9: The manufacturer server returns user login information to the third-party application after verifying the token access_token.

Step 10: The third-party application performs verification on the obtained user login information and locally stored user login information, and completes login after verification succeeds.

Step 11: The third-party application returns a user login state cookie to the H5 page.

In the above procedure where the OAuth2.0 protocol is applied to the mobile client, the authorization credential code generated by the manufacturer server is first delivered to the H5 page (step 5 and step 6) that initiates a request, instead of being directly sent to the third-party application. Therefore, step 5 and step 6 are not atomic operations, and can be externally controlled and interrupted. For example, in step 2, the manufacturer app may be attacked, and extracted current_url may be a malicious H5 page forged by an attacker. In this way, the authorization credential code generated by the manufacturer server is sent to the malicious H5 page. In this way, the attacker may apply for and obtain an authorization credential code of a current user on another valid H5 webpage, and consequently, an account of a victim in a valid H5 application is stolen.

In view of the above, embodiments of this specification provide login authorization methods and apparatuses, to protect against potential account theft attacks.

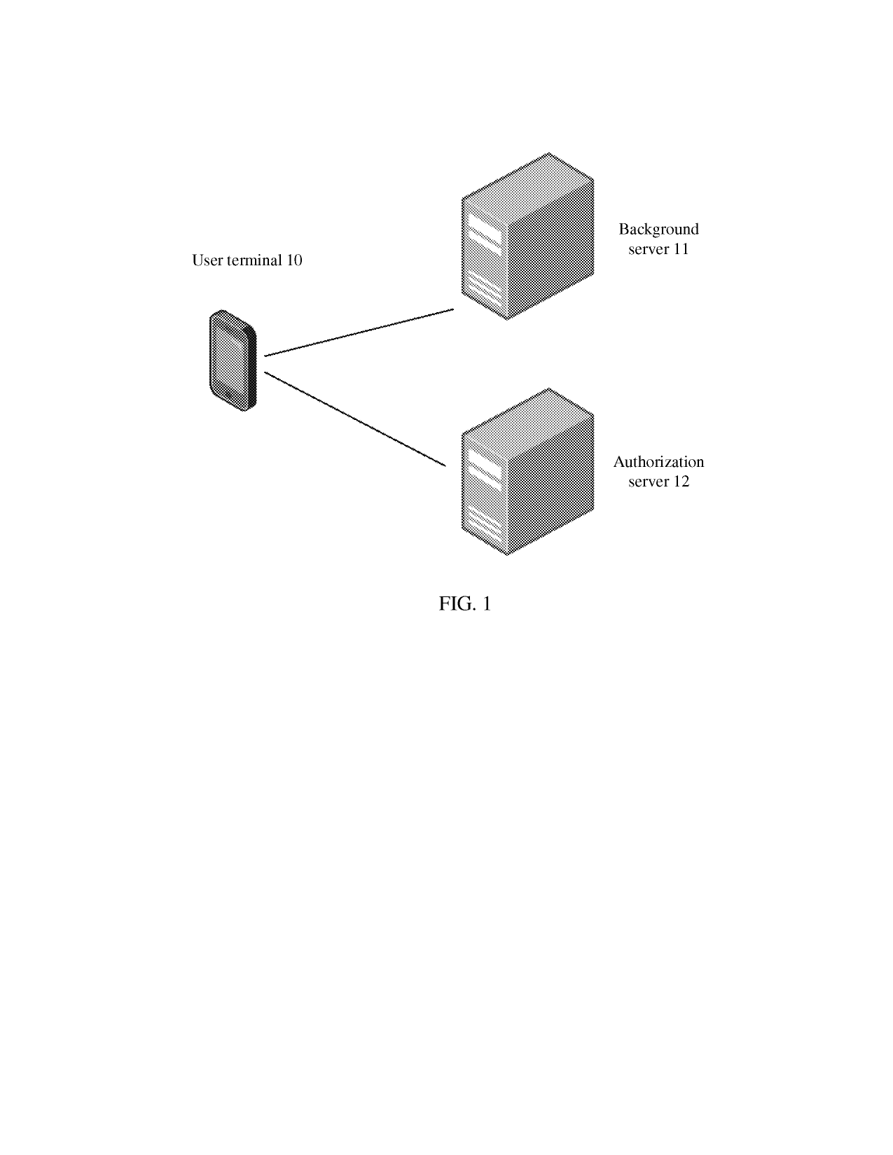

FIG. 1 shows a schematic diagram of a login authorization system, according to one or more embodiments. As shown in FIG. 1, the login authorization system includes a user terminal 10, a background server 11, and an authorization server 12. The user terminal 10 is separately connected to the background server 11 and the authorization server 12 through a communication link. The communication link can be a wired network, or can be a wireless network. For example, the user terminal 10 can establish a communication connection to the background server 11 and/or the authorization server 12 in a communication manner such as Wi-Fi, Bluetooth, and an infrared manner. Alternatively, the user terminal 10 can establish a communication connection to the background server 11 and/or the authorization server 12 through a mobile network. A network standard of the mobile network can be any one of 2G (GSM), 2.5G (GPRS), 3G (WCDMA, TD-SCDMA, CDMA2000, or UTMS), 4G (LTE), 4G+ (LTE+), or WiMax.

The user terminal 10 is a mobile terminal, for example, a mobile phone, a notebook, etc. A front-end application (app) provided by a service provider is installed on the user terminal 10, an H5 web application is installed in the front-end app, and a third-party login authorization function is open to the H5 web application. That is, an H5 page is embedded in the front-end app, and a user can log in to the H5 page based on a login state of the front-end app.

The background server 11, also referred to as the back-end server, is a server of the H5 page, and provides a login authorization and service window for the user on the H5 page embedded in the front-end app. The background server 11 can be any cluster of computing and processing apparatuses, devices, platforms, and devices. In this embodiment, an implementation form of the background server 11 is not limited. For example, the background server 11 can be a single server, or can be a server cluster including a plurality of servers. The background server 11 can also be a cloud server, also referred to as a cloud computing server or a cloud host, and is a host product in a cloud computing service system.

The authorization server 12 is a server provided by the service provider and configured to: respond to a request of the front-end app, and perform corresponding authorization. Similarly, the authorization server 12 can be any apparatus, device, platform, device cluster, virtual server, or cloud server that has a computing and processing capability.

When the login authorization system implements the login authorization method in this embodiment, the user terminal 10, the background server 11, and the authorization server 12 execute the following procedure.

Step 1: After the user logs in to the front-end app on the mobile terminal 10, send an authorization request to the front-end app through the H5 page embedded in the front-end app.

Step 2: The front-end app applies for an authorization credential code from the authorization server 12 based on the authorization request.

Step 3: The authorization server 12 returns the authorization credential code to the front-end app.

Step 4: The front-end app sends the authorization credential code to the background server 11 of the H5 page based on a callback address in the authorization request.

Step 5: The background server 11 applies for a token from the authorization server 12 based on the authorization credential code.

Step 6: The authorization server 12 delivers the token after verifying that the authorization credential code is correct.

Step 7: The background server 11 requests user login information from the authorization server 12 based on the token.

Step 8: The authorization server 12 returns the user login information after verifying that the token is correct.

Step 9: The background server 11 completes login on the H5 page based on the user login information.

After the login, the background server 11 can return a user login state cookie to the front-end app for caching. The user login state cookie is an access token for accessing a resource of the background server 11 by the H5 page. When the user needs to access data of the back server 11, the H5 page does not directly access the background server 11, but sends a data obtaining request to the front-end app. After concatenating the data obtaining request with the user login state cookie, the front-end app sends the data obtaining request and the user login state cookie that are concatenated to the background server 11. After checking the user login state cookie, the background server 11 returns response data to the front-end app for the data obtaining request. The front-end app sends the response data to the H5 page.

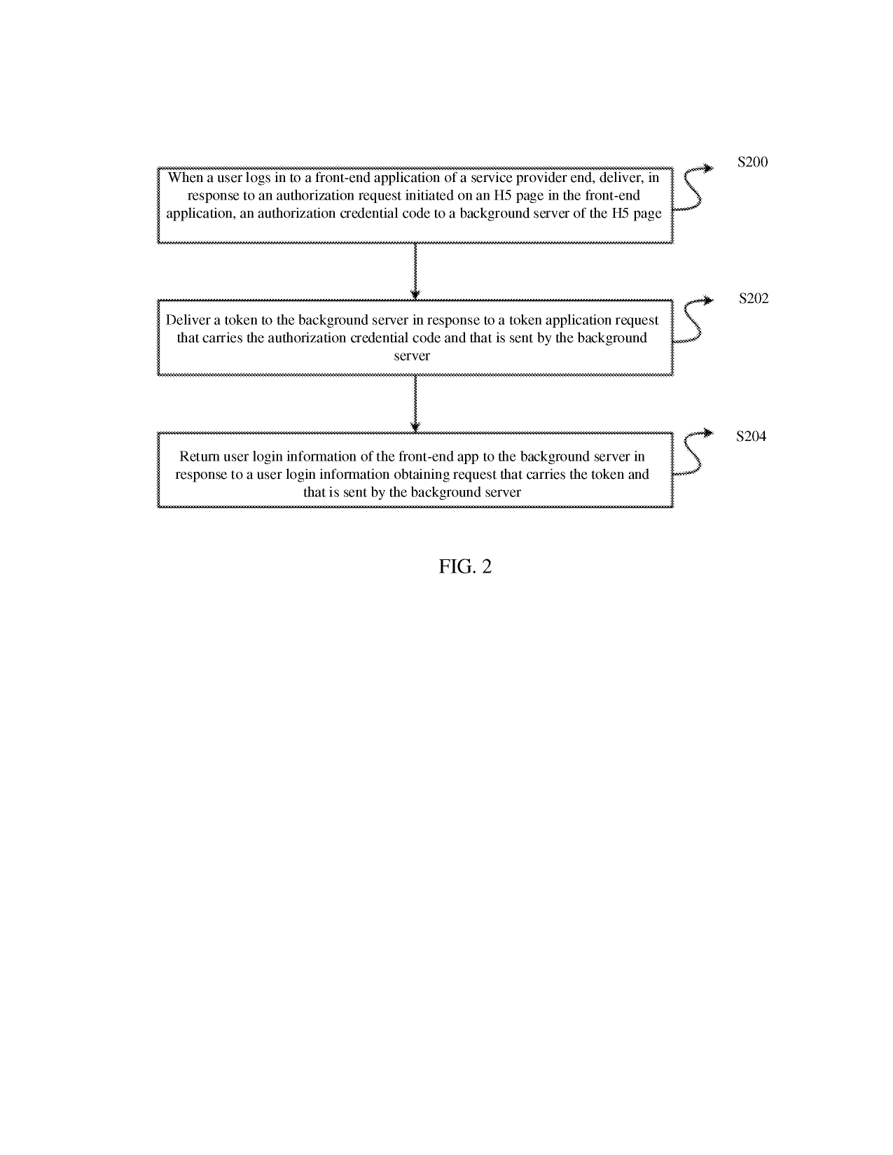

FIG. 2 is a flowchart illustrating a login authorization method applicable to a service provider end, according to one or more embodiments. For example, the service provider end includes a front-end app and an authorization server 12 in FIG. 2. Referring to FIG. 1 and FIG. 2, the method includes step S200 to step S204.

S200: When a user logs in to a front-end app of the service provider end that is installed on the user terminal 10, deliver, in response to an authorization request initiated on an H5 page in the front-end app, an authorization credential code to the background server 11 of the H5 page.

In some embodiments, before the authorization server 12 delivers the authorization credential code to the background server 11, the following steps are further performed: extracting domain name information current_url of the H5 page based on the authorization request; obtaining, based on an identifier appid carried in the authorization request, a callback address submitted by the background server 11 when the service provider end registers; and determining, based on a consistency between the domain name information current_url and the callback address, whether the H5 page is valid.

For example, if the domain name information current_url is consistent with the callback address submitted by the background server 11 when the service provider end registers, or is one of a plurality of callback addresses submitted by the background server 11 when the service provider end registers, it is determined that the H5 page is valid; otherwise, it is determined that the H5 page is invalid.

After verifying that the H5 page is valid, the authorization server 12 queries whether the user agrees to grant authorization, that is, the H5 page is redirected to an authorization page website provided by the authorization server 12, and obtains confirmation information of the user about current authorization on an authorization page.

After the user confirms authorization, the authorization server 12 generates an authorization credential code for this request, concatenates the authorization credential code after the callback address, delivers the authorization credential code and the callback address that are concatenated to the front-end app in a 302 redirect manner, and then the front-end app sends the authorization credential code and the callback address that are concatenated to the H5 page.

S202: Deliver a token to the background server 11 in response to a token application request that carries the authorization credential code and that is sent by the background server 11.

The authorization credential code is an intermediate temporary credential in an authorization procedure, and is a temporary certificate for an operation that the user confirms authorization. A lifecycle of the authorization credential code is usually short. In such an effective time period, the background server 11 can exchange for an access token with the authorization server 12 by using the temporary certificate.

The authorization server 12 verifies validity of the authorization credential code, and delivers the token after verification succeeds. Permission of the token is to enable the background server 11 to obtain user login information in the authorization server 12.

S204: In response to a user login information obtaining request that carries the token and that is sent by the background server 11, return user login information of the front-end app to the background server 11, so that the background server 11 completes login on the H5 page based on the user login information of the front-end app.

After obtaining the token, the background server 11 requests the user login information from the authorization server 12 based on the token. After verifying permission and authenticity of the token, the authorization server 12 returns the user login information of the front-end app to the background server 11, so that the background server 11 can complete login on the H5 page based on the user login information of the front-end app.

In some embodiments, after completing the login on the H5 page, the background server 11 generates a user login state cookie, and sends the user login state cookie to the front-end app for caching as a token for accessing the background server 11.

When the user sends, on the H5 page, a data obtaining request for accessing the background server 11, the front-end app concatenates the data access request with the user login state cookie, sends the data access request and the user login state cookie that are concatenated to the background server 11, and then sends, to the H5 page, response data returned by the background server 11.

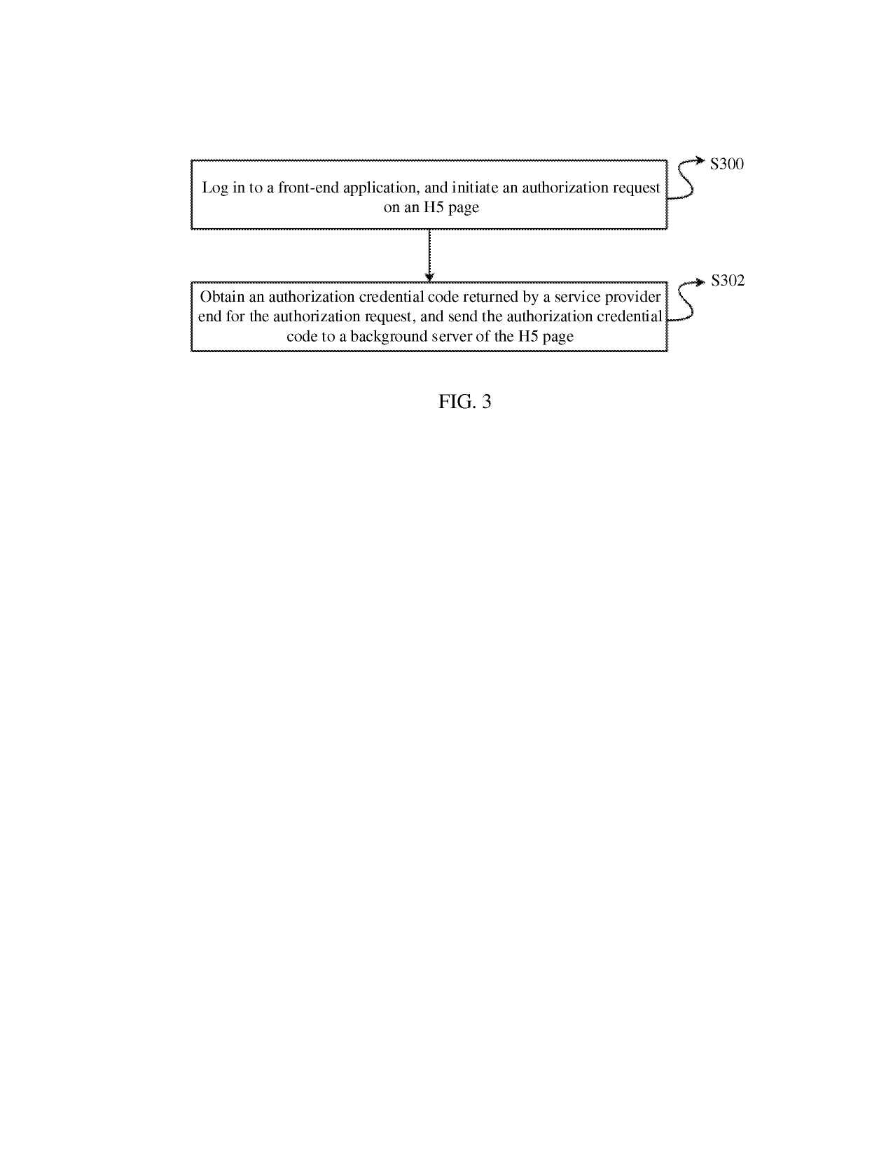

FIG. 3 is a flowchart of a login authorization method applicable to a mobile terminal, according to one or more embodiments. Referring to FIG. 1 and FIG. 3, the method includes steps S300 and S302.

S300: Log in to a front-end app, and initiate an authorization request on an H5 page.

In the embodiments, the front-end app provided by the service provider end is installed on a mobile terminal, such as the user terminal 10, and an H5 page is embedded in the front-end app. Therefore, after logging in to the front-end app on the mobile terminal, a user can log in to the H5 page based on a login state of the front-end app. When the user opens the H5 page, the authorization request is sent to the front-end app of the service provider end on the H5 page. The authorization request carries an identifier appid obtained by a background server 11 of the H5 page when an authorization server 12 of the service provider end registers.

S302: Obtain an authorization credential code returned by the service provider end for the authorization request, and send the authorization credential code to the background server 11 of the H5 page, so that the background server 11 applies for a token from the service provider end, and obtains user login information of the front-end app based on the token, to complete login on the H5 page based on the user login information.

Because the authorization credential code is a user authorization credential that is valid for a short period, the user login information cannot be directly requested from the authorization server 12 based on the authorization credential code. Therefore, after obtaining the authorization credential code, the background server 11 exchanges, with the authorization server 12 within the period of the authorization credential code, for a token that is valid for a long period. Permission of the token enables obtaining of the user login information of the front-end app in the authorization server 12.

After obtaining the token, the background server 11 can request the user login information of the front-end app from the authorization server 12 based on the token, and then match the obtained user login information with user information locally stored in the mobile terminal. If matching succeeds, the login is completed on the H5 page. After logging in to the H5 page, the user can access the background server 11 on the H5 page.

In some embodiments, after completing login to a third-party application, the background server 11 generates a user login state cookie, and sends the user login state cookie to the front-end app for caching.

When the H5 page initiates a data obtaining request for accessing the background server 11, the front-end app sends the data obtaining request and the user login state cookie to the background server together, and sends, to the H5 page, response data returned by the background server.

In the above embodiments, the login authorization method improves a login authorization procedure based on an OAuth2.0 protocol. An authorization credential delivered by the service provider end is directly sent to the background server 11 of the H5 page, and the user login state cookie generated by the background server 11 is cached in the front-end app. In this way, an authorization credential related to login authorization and a finally derived user login state cookie are invisible to the H5 page. Even if an attacker can successfully obtain a code by forging the H5 page, the attacker cannot consume a user login state cookie of a victim, because a server domain name that can be accessed by the H5 page is strictly limited by a whitelist, and the forged H5 page cannot directly access a background server of a valid H5 page. According to the above-mentioned principle, security in a login authorization process can be improved, and account information of the user on the valid H5 page is prevented from being disclosed.

Embodiments of this specification further provide a login authorization apparatus, including an authorization server cooperating with a front-end app. An H5 page is embedded in the front-end app; the front-end app is configured to: in a login state, in response to an authorization request sent on the H5 page, apply for an authorization credential from the authorization server, and return the authorization credential to the H5 page; and the authorization server is configured to: in response to a request of the front-end app for the authorization credential, generate the authorization credential, deliver the authorization credential to the front-end app, and deliver a token to a background server in response to a token application request that carries the authorization credential and that is sent by the background server.

In some embodiments, the front-end app is configured to: extract domain name information of the H5 webpage based on the authorization request, and send, to the authorization server together, the domain name information and an identifier carried in the authorization request.

Correspondingly, before generating the authorization credential, the authorization server further checks validity of the H5 page, specifically including: obtaining, based on the identifier carried in the authorization request, a callback address submitted by the background server during registration; determining, based on a consistency between the domain name information extracted by the front-end app and the callback address, whether the H5 page is valid; and if the domain name information is consistent with the callback address, determining that the H5 page is valid; otherwise, determining that the H5 page is invalid.

In some embodiments, the front-end app is further configured to: in response to login on the H5 page, cache a user login state cookie sent by the background server 11; and when receiving a data access request sent by the H5 page, send the data access request and the user login state cookie to the background server together, and send, to the H5 page, response data returned by the background server.

Embodiments of this specification further provide a mobile terminal. A front-end app provided by a service provider end is installed on the mobile terminal, and an H5 page is embedded in the front-end app. The mobile terminal can log in to the H5 page based on a login state of the front-end app, specifically including: initiating an authorization request on the H5 page; sending the authorization request to an authorization server of the service provider end by using the front-end app; and obtaining, by using the front-end app, an authorization credential returned by the authorization server for the authorization request, and sending the authorization credential to a background server of the H5 page, so that the background server applies for a token from the authorization server, obtains user login information of the front-end app based on the token, and completes login on the H5 page based on the user login information.

In some embodiments, after logging in to the H5 page, the mobile terminal can access the background server in the following manner, specifically including: after logging in to the H5 page, caching, by using the front-end app, a user login state cookie returned by the background server; initiating, on the H5 page, a data obtaining request for accessing the background server; and sending the data obtaining request and the user login state cookie to the background server together by using the front-end app, and sending, to the H5 page, response data returned by the background server.

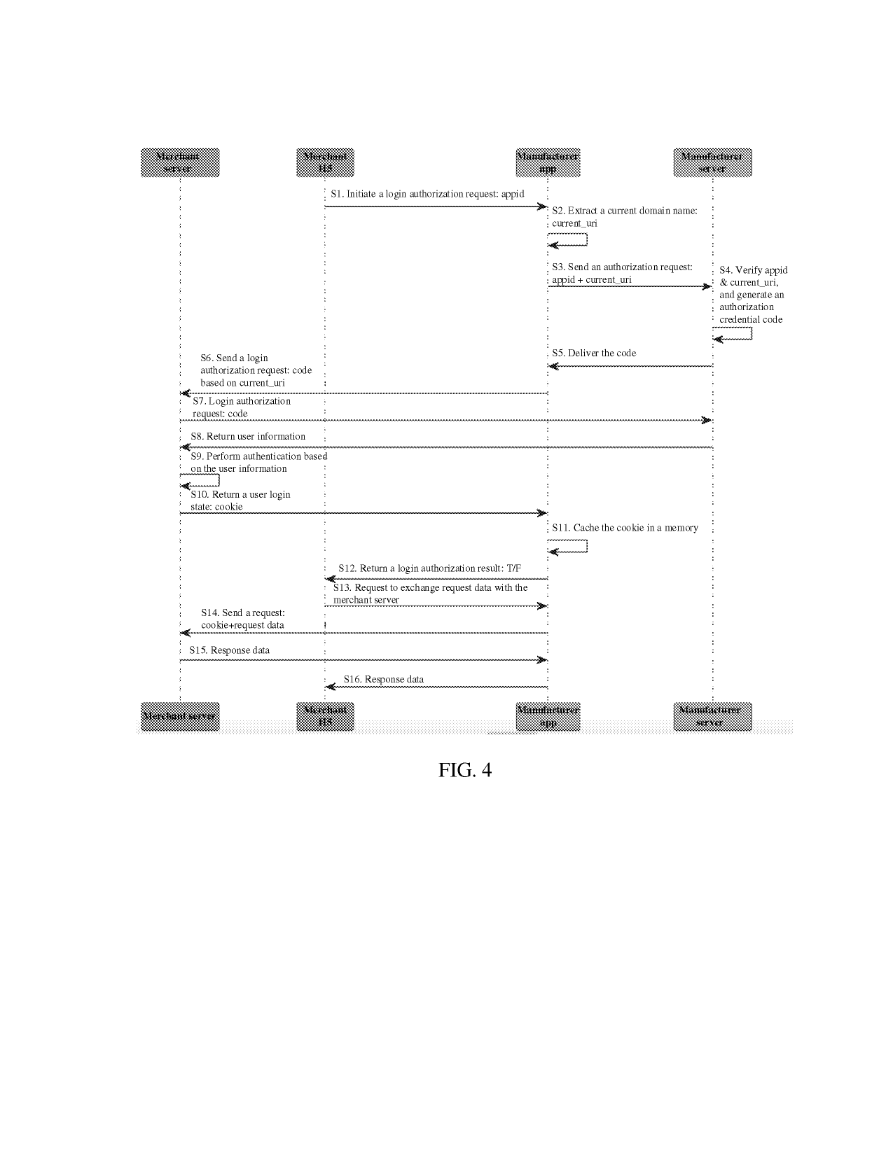

FIG. 4 is a schematic diagram illustrating a working procedure of a login authorization method, according to one or more embodiments. As shown in FIG. 4, the login procedure includes steps S401 to S416.

S1: A merchant H5 page sends, to a manufacturer app, a login authorization request that carries an identifier appid, where appid is issued by a manufacturer server when a merchant server requests the manufacturer server to grant authorization.

S2: The manufacturer app extracts a current domain name current_url of the merchant H5 page.

S3: The manufacturer app concatenates the identifier appid and the domain name current_url in a login authorization request, and sends the login authorization request to the manufacturer server.

S4: The manufacturer server verifies the identifier appid and the domain name current_url, and generates an authorization credential code if it is determined that the identifier appid and the domain name current_url are correct.

S5: The manufacturer server sends the authorization credential code to the manufacturer app.

S6: The manufacturer app sends the authorization credential code to the merchant server.

S7: The merchant server applies to exchange for a token from the manufacturer server based on the authorization credential code, and requests user login information of the manufacturer app from the manufacturer server based on the token.

S8: After verifying that the token is correct, the manufacturer server sends the user login information of the manufacturer app to the merchant server.

S9. After obtaining the user login information of the manufacturer app, the merchant server compares the user login information with locally stored user information. If the user login information is consistent with the locally stored user information, authentication succeeds, and the merchant server completes the login on the merchant H5 page.

S10: After completing the login on the merchant H5 page, the merchant server generates a user login state cookie, and sends the user login state cookie to the manufacturer app.

S11: The manufacturer app caches the user login state cookie in a memory.

S12: After caching the user login state cookie, the manufacturer app returns a login authorization result (login success/login failure) to the merchant H5 page.

S13: After login, the merchant H5 page can send a data obtaining request for accessing the merchant server to the manufacturer app.

S14: The manufacturer app concatenates the received data obtaining request and the cached user login state cookie, and then sends the received data obtaining request and the cached user login state cookie that are concatenated to the merchant server.

S15: The merchant server returns response data to the manufacturer app.

S16: The manufacturer app sends the response data to the merchant H5 page.

A person skilled in the art should understand that the steps of the login authorization method described above can be implemented by using a general-purpose computing apparatus, and can be integrated in a single computing apparatus or distributed in a network including a plurality of computing apparatuses. In some embodiments, the steps can be implemented by using program code that can be executed by the computing apparatus. Therefore, the program code can be stored in a storage apparatus and executed by the computing apparatus. In some cases, the shown or described steps can be executed in an order different from that herein, or the steps can be separately programed into integrated circuit modules, or a plurality of modules or steps are fabricated into a single integrated circuit module for implementation. In this way, the present disclosure is not limited to any specific combination of hardware and software.

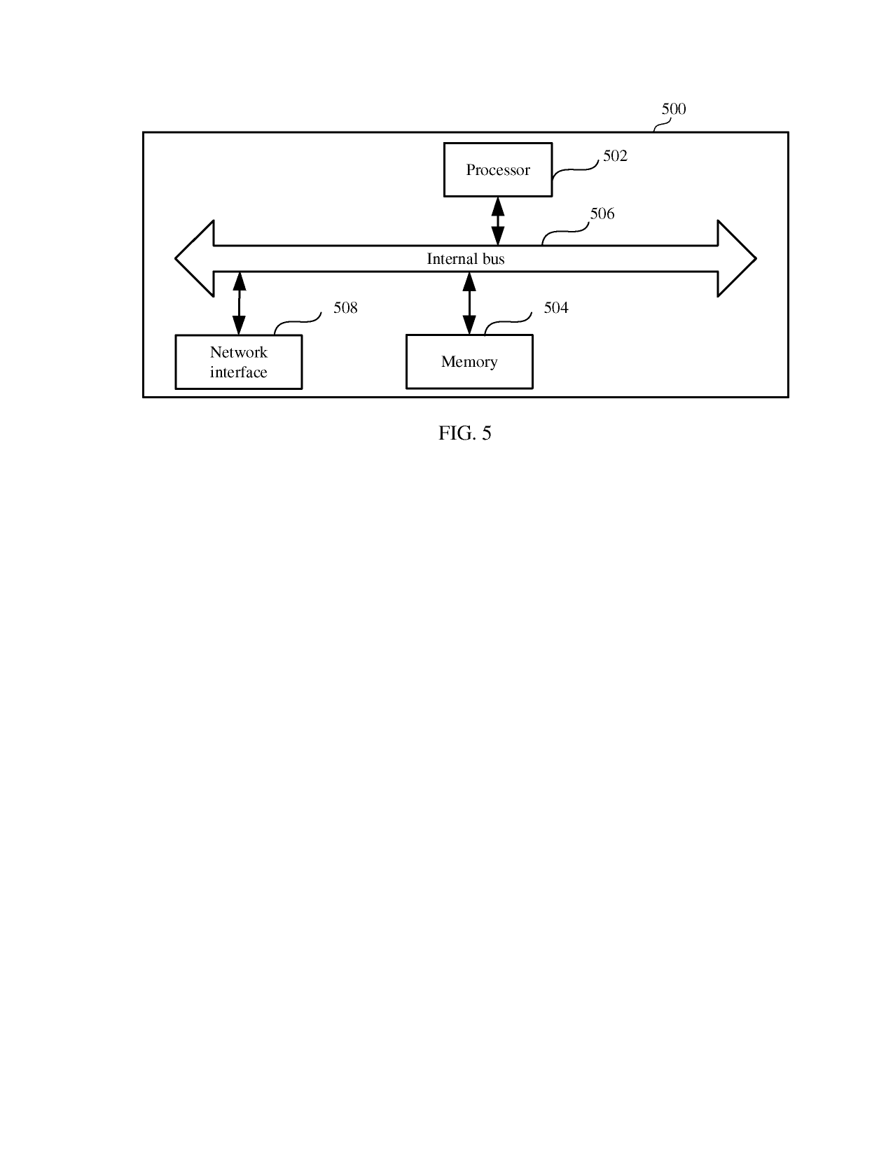

FIG. 5 is a schematic diagram of a login authorization apparatus 500, according to one or more embodiments. For example, the login authorization apparatus 500 may be any of the user terminal 10, the background server 11, or the authorization server 12 described above. The login authorization apparatus 500 includes a processor 502 and a memory 504 storing instructions executable by the processor 502, and may also include an internal bus 506, a network interface 508, or other needed hardware. The processor 502 is configured to perform the login authorization method described above.

Embodiments of this specification provide login authorization methods and apparatuses, to avoid a problem that user information on an H5 page is disclosed in a process in which a mobile terminal logs in to the H5 page in a front-end app based on a login state of the front-end app.

According to a first aspect of this specification, a login authorization method is applied to a service provider end, and includes: when a user logs in to a front-end app of the service provider end, delivering an authorization credential to a background server of an H5 page in the front-end app in response to an authorization request sent on the H5 page; delivering a token to the background server in response to a token application request that carries the authorization credential and that is sent by the background server; and in response to user login information obtaining request that carries the token and that is sent by the background server, delivering user login information of the front-end app to the background server, so that the background server completes login on the H5 page based on the user login information.

In an implementation, the method further includes: in response to the login on the H5 page, storing, by using the front-end app, a user login state cookie sent by the background server; and in response to a data access request sent by the H5 page, sending the data access request and the user login state cookie to the background server together by using the front-end app, and sending, to the H5 page, response data returned by the background server.

In an implementation, before the delivering the authorization credential to the background server, the method further includes: extracting domain name information of the H5 page based on the authorization request; obtaining, based on an identifier carried in the authorization request, a callback address submitted by the background server when the service provider end registers; and determining, based on a consistency between the domain name information and the callback address, whether the H5 page is valid.

According to a second aspect of this specification, a login authorization method is applied to a mobile terminal. A front-end app provided by a service provider end is installed on the mobile terminal, an H5 page is embedded in the front-end app, and the method includes: logging in to the front-end app, and initiating an authorization request on the H5 page; and obtaining an authorization credential returned by the service provider end for the authorization request, and sending the authorization credential to a background server of the H5 page, wherein the background server applies for a token from the service provider end, obtains user login information of the front-end app based on the token, and completes login on the H5 page based on the user login information.

In an implementation, the method further includes: after logging in to the H5 page, caching, by using the front-end app, a user login state cookie returned by the background server; and when the H5 page sends a data obtaining request for accessing the background server to the service provider end, sending the data obtaining request and the user login state cookie to the background server together by using the front-end app, and sending, to the H5 page, response data returned by the background server.

According to a third aspect of this specification, an authorization apparatus includes a front-end app and an authorization server. An H5 page is embedded in the front-end app; the front-end app is configured to: in a login state, in response to an authorization request sent on the H5 page, apply for an authorization credential from the authorization server, and return the authorization credential to the H5 page; and the authorization server is configured to: in response to a request of the front-end app for the authorization credential, generate the authorization credential, deliver the authorization credential to the front-end app, and deliver a token to a background server of the H5 page in response to a token application request that carries the authorization credential and that is sent by the background server.

In an implementation, the front-end app is further configured to: extract domain name information of the H5 webpage based on the authorization request, and send, to the authorization server together, the domain name information and an identifier carried in the authorization request.

In an implementation, before generating the authorization credential, the authorization server further checks validity of the H5 page, including: obtaining, based on the identifier carried in the authorization request, a callback address submitted by the background server during registration; and determining, based on a consistency between the domain name information extracted by the front-end app and the callback address, whether the H5 page is valid.

In an implementation, the front-end app is further configured to: in response to login on the H5 page, cache a user login state cookie sent by the background server; and when receiving a data access request sent by the H5 page, send the data access request and the user login state cookie to the background server together, and send, to the H5 page, response data returned by the background server.

According to a fourth aspect of this specification, a mobile terminal is installed with a front-end app provided by a service provider end. An H5 page is embedded in the front-end app, and the mobile terminal logs in to the H5 page based on a login state of the front-end app. The mobile terminal includes a processor, and a memory storing instructions executable by the processor. The processor is configured to: initiate an authorization request on the H5 page; send the authorization request to an authorization server of the service provider end by using the front-end app; and obtain, by using the front-end app, an authorization credential returned by the authorization server for the authorization request, and send the authorization credential to a background server of the H5 page, wherein the background server applies for a token from the authorization server, obtains user login information of the front-end app based on the token, and completes login on the H5 page based on the user login information.

In an implementation, after logging in to the H5 page, for the mobile terminal to access the background server, the processor is further configured to: after logging in to the H5 page, cache, by using the front-end app, a user login state cookie returned by the background server; initiate, on the H5 page, a data obtaining request for accessing the background server; and send the data obtaining request and the user login state cookie to the background server together by using the front-end app, and send, to the H5 page, response data returned by the background server.

Beneficial effects of the login authorization method and apparatus described above include, e.g., in a login authorization process based on an OAuth2.0 protocol, an authorization credential delivered by a service provider end is directly sent to a background server of an H5 page, so that the authorization credential is invisible to the H5 webpage, thereby greatly reducing a possibility that an attacker obtains the authorization credential by forging the H5 webpage, and reducing a risk of disclosing user login information in an H5 web application in the login authorization process.

The embodiments of this specification are described in a progressive manner. For same or similar parts in the embodiments, references can be made to each other.

Example embodiments of this specification are described above. Other embodiments fall within the scope of the appended claims. In some cases, the actions or steps described in the claims can be performed in an order different from that in the embodiments and desired results can still be achieved. In addition, the process depicted in the accompanying drawings does not necessarily require the shown particular execution order to achieve the desired results. In some implementations, multitasking and parallel processing are feasible or may be advantageous.

It should be noted that the present disclosure is not limited to the above example embodiments. All variations based on the described embodiments shall fall within the protection scope of the present disclosure.

1. A login authorization method, applied to a service provider end, the method comprising:
when a user logs in to a front-end application (app) installed on a user terminal, delivering an authorization credential to a background server of an H5 page in the front-end app in response to an authorization request sent on the H5 page;
delivering a token to the background server in response to a token application request that carries the authorization credential and that is sent by the background server; and
in response to user login information obtaining request that carries the token and that is sent by the background server, delivering user login information of the front-end app to the background server, wherein the background server completes login on the H5 page based on the user login information.

2. The method according to claim 1, further comprising:
in response to the login on the H5 page, storing, by using the front-end app, a user login state cookie sent by the background server; and
in response to a data access request sent by the H5 page, sending the data access request and the user login state cookie to the background server together by using the front-end app, and sending, to the H5 page, response data returned by the background server.

3. The method according to claim 1, before the delivering the authorization credential to the background server, the method further comprising:
extracting domain name information of the H5 page based on the authorization request;
obtaining, based on an identifier carried in the authorization request, a callback address submitted by the background server when the service provider end registers; and
determining, based on a consistency between the domain name information and the callback address, whether the H5 page is valid.

4. A login authorization method, applied to a mobile terminal, wherein a front-end application (app) provided by a service provider end is installed on the mobile terminal, an H5 page is embedded in the front-end app, and the method comprises:
logging in to the front-end app, and initiating an authorization request on the H5 page; and
obtaining an authorization credential returned by the service provider end for the authorization request, and sending the authorization credential to a background server of the H5 page, for the background server to apply for a token from the service provider end, obtain user login information of the front-end app based on the token, and complete login on the H5 page based on the user login information.

5. The method according to claim 4, further comprising:
after logging in to the H5 page, caching, by using the front-end app, a user login state cookie returned by the background server; and
when the H5 page sends a data obtaining request for accessing the background server to the service provider end, sending the data obtaining request and the user login state cookie to the background server together by using the front-end app, and sending, to the H5 page, response data returned by the background server.

6. An authorization server, comprising:
a processor; and
a memory storing instructions executable by the processor,
wherein an H5 page is embedded in a front-end application (app), and the front-end app is configured to: in a login state, in response to an authorization request sent on the H5 page, apply for an authorization credential from the authorization server, and return the authorization credential to the H5 page; and
the processor is configured to: in response to a request of the front-end app for the authorization credential, generate the authorization credential, deliver the authorization credential to the front-end app, and deliver a token to a background server of the H5 page in response to a token application request that carries the authorization credential and that is sent by the background server.

7. The authorization server according to claim 6, wherein the front-end app is further configured to: extract domain name information of the H5 page based on the authorization request, and send, to the authorization server together, the domain name information and an identifier carried in the authorization request.

8. The authorization server according to claim 7, wherein before generating the authorization credential, the processor is further configured to check validity of the H5 page by:
obtaining, based on the identifier carried in the authorization request, a callback address submitted by the background server during registration; and
determining, based on a consistency between the domain name information extracted by the front-end app and the callback address, whether the H5 page is valid.

9. The authorization server according to claim 6, wherein the front-end app is further configured to: in response to login on the H5 page, cache a user login state cookie sent by the background server; and when receiving a data access request sent by the H5 page, send the data access request and the user login state cookie to the background server together, and send, to the H5 page, response data returned by the background server.

10. A mobile terminal, installed with a front-end application (app) provided by a service provider end, and comprising:
a processor; and
a memory storing instructions executable by the processor,
wherein an H5 page is embedded in the front-end app, and
for the mobile terminal to log in to the H5 page based on a login state of the front-end app, the processor is configured to:
initiate an authorization request on the H5 page;
send the authorization request to an authorization server of the service provider end by using the front-end app; and
obtain, by using the front-end app, an authorization credential returned by the authorization server for the authorization request, and send the authorization credential to a background server of the H5 page, wherein the background server applies for a token from the authorization server, obtains user login information of the front-end app based on the token, and completes login on the H5 page based on the user login information.

11. The mobile terminal according to claim 10, wherein after logging in to the H5 page, for the mobile terminal to access the background server, the processor is further configured to:
after logging in to the H5 page, cache, by using the front-end app, a user login state cookie returned by the background server;
initiate, on the H5 page, a data obtaining request for accessing the background server; and
send the data obtaining request and the user login state cookie to the background server together by using the front-end app, and send, to the H5 page, response data returned by the background server.
